(19) United States
(12) Patent Application Publication
(10) Pub. No.: US 2015/0097107 A1
(43) Pub. Date: Apr. 9, 2015

(54) APPARATUS FOR GENERATING EXTREME ULTRAVIOLET LIGHT USING PLASMA

(71) Applicant: FST INC., Hwaseong-si, Gyeonggi-do (KR)

(72) Inventors: Jae Won Lim, Seongnam-si (KR); Bu Yeob Yoo, Hwaseong-si (KR); Jong Lip Choi, Fremont, CA (US)

(21) Appl. No.: 14/386,003

(22) PCT Filed: Mar. 19, 2013
(86) PCT No.: PCT/KR2013/002249

§ 371 Date: Sep. 18, 2014

(30) Foreign Application Priority Data
Mar. 20, 2012 (KR) 10-2012-0025462
Mar. 20, 2012 (KR) 10-2012-0028462
Mar. 20, 2012 (KR) 10-2012-0028463

(51) Int. Cl. H05G 2/00

(52) U.S. Cl. CPC H05G 2/008; H05G 2/003
USPC 250/208.1; 250/504 R

(57) ABSTRACT

Disclosed is an apparatus for generating EUV light by means of plasma, the apparatus comprising: a laser source for outputting laser; a tunable laser mirror (TLM) for reflecting laser beams from the laser source; a focusing mirror (FM) for focusing the laser beams reflected from the TLM; a gas cell for generating EUV light by forming a plasma from the laser beams and reaction gas, the laser being incident on the gas cell after being focused on the TM, and the reaction gas being supplied by a gas supply line for a plasma-induced path corresponding to a section on the gas cell in which the focal point of the incident laser occurs; and a vacuum chamber for accommodating the TLM, FM and the gas cell in a state of vacuum. The present invention having features as discussed has the benefit of allowing simple but effective generation of EUV light.

### TECHNICAL FIELD

The present invention relates to an apparatus for generating extreme ultraviolet (EUV) using plasma and, more particularly, to an apparatus for generating EUV, wherein a structure is simplified to a maximum extent and a EUV beam is able to be generated.

### BACKGROUND ART

As the degree of integrations of semiconductor integrated circuits is increased, a circuit pattern becomes fine and thus the resolution of the circuit pattern is reduced in a conventional exposure apparatus using a visible ray or ultraviolet rays. In a semiconductor manufacture process, the resolution of an exposure apparatus is proportional to The Numerical Aperture (NA) of a transcription optical system and is in inverse proportion to the wavelength of light used in the exposure of light. For this reason, in order to improve resolution, attempts using a EUV light source having a short wavelength instead of a visible ray or ultraviolet rays in light exposure transcription are being made. A EUV light generation apparatus used as such a light exposure transcription apparatus includes a laser plasma EUV light source and a discharge plasma EUV light source.

A wavelength used in a EUV light exposure apparatus is 20 nm or less and includes a light source representatively using 13.5 nm. To use Ne plasma using Ne gas as the reaction substance of a laser plasma light source is widely developed. The reason for this is that Ne plasma has relatively high conversion efficiency (a ratio of the EUV light intensity obtained with respect to input energy). Ne has a problem in that scattered debris is difficult to occur because it is a substance, that is, gas at normal temperature. However, using Ne gas as a target in order to obtain a EUV light source having high output is limited, and other substances need to be used.

In general, in a vacuum ultraviolet region having a light wavelength of 200 nm˜10 nm, a region 200 nm˜100 nm corresponding to a half on the long wavelength side is defined as VUV light, and a region 100 nm˜10 nm corresponding to a half on the short wavelength side is defined as EUV light. EUV light that is generated from plasma and that has a center wavelength of about 100 nm or less is absorbed by the atmosphere or an optical system, such as a condensing mirror (using common reflection coating), without being reflected therefrom. Accordingly, there is a difficult in the industry in improving EUV light conversion efficiency.

In a short wavelength region, such as a EUV laser, many problems, such as a laser oscillation method, a measurement method and optical materials used, have not been solved, and to develop application fields is also a future problem. Accordingly, in order to solve a problem in that EUV light becomes extinct in the atmosphere or an optical system, a vacuum environment (<10⁻³ torr) of specific pressure or less is required, and a condensing mirror and lens coated with a special substance needs to be used.

Accordingly, there is a need to develop a EUV light generation apparatus using laser plasma more efficiently by applying such conditions.

Accordingly, Korean Patent Application No. 10-2011-0017579 entitled “Stabilized Apparatus for Generating Extreme Ultraviolet Rays Using Plasma” by the applicant of this application is described below with reference to FIG. 1. The apparatus is configured to include a laser source 10 configured to output a laser, a gas cell 20 configured to receive the laser output by the laser source, receive gas supplied by a gas supply line with respect to a plasma induction line corresponding to a section that is focused, form plasma using the laser and the gas, and generate EUV, and receive the gas cell therein, a first vacuum chamber unit 30 configured to maintain a specific degree of vacuum, a second vacuum chamber unit 40 that is a space for receiving the EUV light generated by the gas cell and for externally outputting the EUV light and that maintains a specific degree of vacuum, a gas supply unit configured to supply gas for inducing a laser and plasma to the gas supply line of the gas cell, a first vacuum pump and a second vacuum pump configured to form the degree of vacuum in the first vacuum chamber unit and the degree of vacuum in the second vacuum chamber unit, respectively, and a plurality of optical systems 71 to 75 configured to deliver light output by the laser source.

The EUV generation apparatus configured as above is an invention filed by the applicant of this application and corresponds to a very excellent technology capable of generating stabilized EUV light through a plasma reaction.

However, it is difficult to design the apparatus for generating EUV light because a structure is very complicated, and thus a laser alignment or equipment deployment process is complicated. Furthermore, the apparatus is disadvantageous in appealing to industry applications because many parts attributable to the complicated structure are required and the costs of production are high.

### DISCLOSURE

### Technical Problem

An object of the present invention for solving problems, such as those described above, is to provide a stabilized apparatus for generating EUV light using plasma, which is capable of simplifying a structure to a maximum extent, generating a stabilized EUV beam, minimizing a reduction of efficiency, and effectively collecting EUV light sources generated from plasma.

Furthermore, an object of the present invention is to provide a plasma induction reaction gas cell capable of generating optimum EUV light through plasma induction using reaction gas.

### Technical Solution

The present invention for achieving the above objects includes a laser source that outputs lasers, a Tunable Laser Mirror (TLM) that reflects the laser beams output by the laser source, a Focusing Mirror (FM) that focuses the laser beams reflected from the TLM, a gas cell that receives the lasers focused by the FM, receives reaction gas supplied from a gas supply line to a plasma induction line corresponding to a section that is focused, forms plasma using the laser beams and the reaction gas, and generates EUV light, and a vacuum chamber that accommodates the TLM, the FM, and the gas cell in a vacuum state.

The apparatus is further configured to include a first aperture provided to align pieces of the laser beams focused by the FM and a second aperture configured to transmit only the center wavelength of the EUV light generated by the gas cell.

Furthermore, the vacuum chamber is divided into a first vacuum chamber unit and a second vacuum chamber unit, the second vacuum chamber unit is configured to maintain a higher degree of vacuum than the first vacuum chamber unit, the first vacuum chamber unit is configured to accommodate the TLM, the FM, the gas cell, and the first aperture, and the second vacuum chamber unit is configured to accommodate the second aperture.

The apparatus is configured to further include a beam splitter that reflects part of the light reflected from the TLM and an image sensor that detects a wavefront of the beam reflected from the beam splitter.

Furthermore, the laser source has an IR wave length of 800 nm˜1600 nm and a pulse width of 30 fs˜50 fs.

Furthermore, the first aperture is removable after the beams output by the FM are aligned.

The present invention for achieving the above objects includes a body having a specific length and a length form, light induction lines formed on both sides of the body in the length direction of the body, a plasma induction line placed between the light induction lines, a gas injection line configured to communicate with the plasma induction line and to supply external plasma reaction gas, and gas exhaust lines that communicate with the light induction lines and that externally exhaust gas present in the plasma induction line.

Furthermore, the body further includes side caps that cover respective open sides of the light induction lines and in which a hole through which light is able to pass is formed.

Furthermore, the side caps are made of metal materials including metal, SUS, aluminum, or copper or made of glass materials including quartz or fused silica.

Furthermore, the body is configured to have a cross-sectional area of 20×20 mm or less.

Furthermore, the plasma induction line is configured to have a width of 0.9˜1.1 mm.

Furthermore, the width B of the light induction line is greater than the width A of the plasma induction line.

Furthermore, the hole E is formed be smaller than the width B of the light induction line.

Furthermore, the number of gas exhaust lines is at least 2.

Furthermore, the body is made of any one of quartz and fused silica.

### Advantageous Effects

The present invention configured and driven as described above is advantageous in that manufacture is easy and the prime cost can be reduced because a structure is very simple in conditions for generating EUV light.

Furthermore, the present invention is advantageous in that beams can be aligned very easily through the simplification of an optical system structure and EUV light generated by the plasma induction gas cell can be stably output because the chamber units are configured to have different degrees of vacuum.

Furthermore, the present invention is advantageous in that it can provide the plasma induction gas cell optimally designed for plasma induction using source light and reaction gas in order to generate EUV light through the plasma induction.

### DESCRIPTION OF DRAWINGS

FIG. 1 is a diagram illustrating the configuration of an apparatus for generating EUV light using plasma according to a prior art,

FIG. 2 is a diagram illustrating the configuration of an apparatus for generating EUV light using plasma according to the present invention,

FIG. 3 is a detailed diagram of the apparatus for generating EUV light using plasma according to the present invention,

FIG. 4 is a perspective view of a plasma induction gas cell for generating EUV light according to the present invention,

FIG. 5 is a perspective view illustrating the transmission of the plasma induction gas cell according to the present invention,

FIG. 6 is a cut-away perspective view of the plasma induction gas cell according to the present invention,

FIG. 7 is a cross-sectional view of the plasma induction gas cell according to the present invention,

FIG. 8 is a diagram illustrating the light transmission of the plasma induction gas cell according to the present invention,

FIG. 9 is a cross-sectional view illustrating a plasma induction gas cell in accordance with another embodiment of the present invention,

FIG. 10 is a top view illustrating the state in which the plasma induction gas cell has been fixed through a bracket according to the present invention, and

FIG. 11 is a perspective view of the fixing bracket of the plasma induction gas cell according to the present invention.

### MODE FOR INVENTION

Hereinafter, a preferred embodiment of an apparatus for generating EUV light using plasma according to the present invention is described with reference to the accompanying drawings.

The apparatus for generating EUV light using plasma according to the present invention is configured to include a laser source 100 configured to output a laser, a Tunable Laser Mirror (TLM) 220 configured to reflect the laser beam output by the laser source, a Focusing Mirror (FM) 230 configured to focus the laser beam reflected from the TLM, a gas cell 240 configured to receive the laser focused by the FM, receive reaction gas supplied from a gas supply line to a plasma induction line corresponding to a section that is focused, form plasma using the laser beam and the reaction gas, and generate EUV light, and a vacuum chamber 200, 210 configured to receive the TLM, the FM, and the plasma induction gas cell therein in a vacuum state.

Major technical objects of the apparatus for generating EUV light according to the present invention are to simplify the structure of an optical system for transferring light output by a laser source in an apparatus for generating EUV light and to provide an apparatus for generating EUV light capable of satisfying efficiency of EUV light.

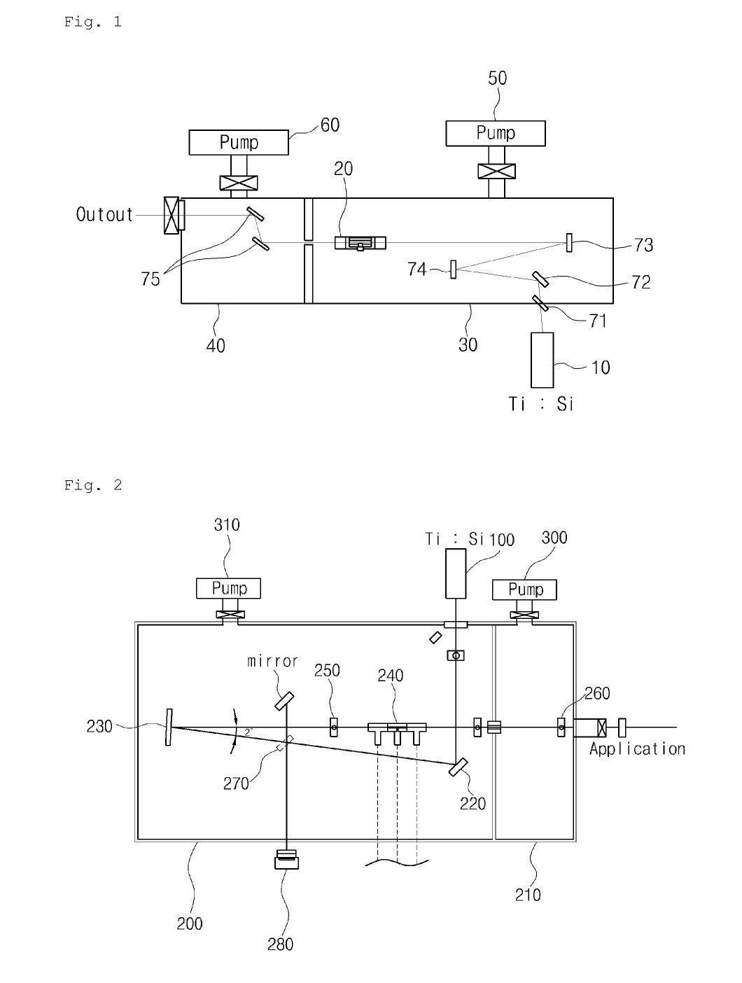

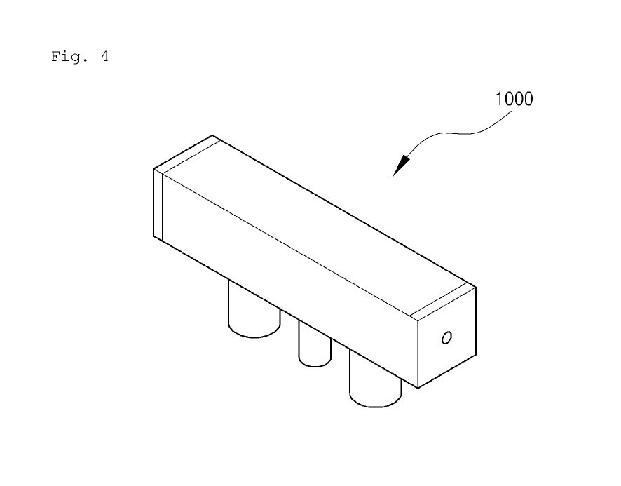

FIG. 2 is a diagram illustrating the configuration of an apparatus for generating EUV light using plasma according to the present invention.

The apparatus for generating EUV light using plasma according to the present invention includes the laser source 100 for outputting a laser beam, the TLM 220 for reflecting the laser beam, the FM 230 for focusing the reflected laser beam, the plasma induction gas cell 240 for generating EUV light through a plasma reaction, and the vacuum chamber for receiving the TLM, the FM, and the plasma induction gas cell.

The laser source 100 is a source that outputs a laser having a specific wavelength. The laser source 100 generates EUV light having a wavelength of 20 nm or less through plasma induction using the laser output by the laser source. In the present invention, for example, a femto second-level laser source is used as the laser source. More specifically, a titanium sapphire amplification laser system is used as a medium and preferably has conditions that a pulse width of an IR femto second pulse laser is 30 fs˜50 fs and an IR wave is 800 nm˜1600 nm.

The TLM is a mirror for reflecting the laser beam output by the laser source placed outside the vacuum chamber. The TLM is disposed in an incident path output from the laser source and reflects the incident laser beam to the FM 230 to be described later. In this case, the TLM reflects the incident laser beam to the FM so that the laser beam has an incident angle of approximately 2°. That is, the TLM reflects the incident laser beam so that an incident angle of the laser beam incident to the FM is approximately 2°.

The FM 230 focuses and reflects the incident light so that EUV light is generated. The laser beam generated by the laser source is reflected from the TLM and then reflected toward the FM. The FM focuses the incident laser beam on the plasma induction gas cell for generating EUV light through plasma induction.

The gas cell includes transparent materials and preferably is made of quartz. A through line through a laser may pass is formed in the plasma induction gas cell. A plasma induction line, that is, a focus region into which the laser output by the laser source is condensed, is provided at the center of the plasma induction gas cell. Exhaust lines 320 are formed on both sides of the plasma induction line. The gas supply line for supplying gas to the plasma induction line is connected to the plasma induction line.

The gas cell 240 is made of transparent materials. Light induction lines are formed on both sides of the plasma induction gas cell. The plasma induction line is formed at the center of the plasma induction gas cell in order to connect the light induction line to the plasma induction gas cell. Light reflected from the FM is focused so that it is condensed into the central part of the plasma induction line. The light reacts to reaction gas supplied to the plasma induction line, thereby generating EUV light. That is, the focus of the laser output by the laser source is condensed into the plasma induction line corresponding to the central portion of the plasma induction gas cell, and an external gas supply unit 290 supplies Ne gas through the gas supply line that communicates with the plasma induction line. Furthermore, gas exhaust lines configured to exhaust the supplied gas externally and to maintain the degree of vacuum within the plasma induction line are formed on both sides of the plasma induction line. When the gas supplied through the gas supply line is spread outside the region into which the focus of the laser is condensed, smooth plasma induction is impossible due to the scattering of gas debris. Furthermore, a specific degree of vacuum is required to be maintained in the plasma induction line. If a specific degree of vacuum is not maintained due to various problems (the sealing of the vacuum chamber, impurities within the vacuum chamber, etc.) of a vacuum system, however, it may become a factor to disturb the generation of EUV light. Accordingly, the exhaust of gas and the degree of vacuum are maintained through the gas exhaust lines. The gas exhaust lines exhaust gas through an external drain pump 291 (an apparatus for exhausting gas).

Meanwhile, the vacuum chamber for receiving an element for generating EUV light in a vacuum state is configured. The vacuum chamber is divided into the first vacuum chamber (200) region and the second vacuum chamber (210) region.

The first vacuum chamber unit 200 corresponds to a region in which EUV light is generated, and the second vacuum chamber unit 210 corresponds to a region in which the EUV light generated by the first vacuum chamber unit is stably supplied. In the present invention, EUV light is generated by inducing plasma using a laser beam and external gas. The EUV light is generated through the plasma induction gas cell to be described later. In this case, it is difficult to maintain a specific degree of vacuum because it is difficult to supply gas, such as Ne, Xe, or He, from the outside to the inside of the plasma induction gas cell. Accordingly, efficiency of EUV light generated by the plasma induction gas cell may be low in the chamber in which the plasma induction gas cell is placed. Accordingly, the plasma induction gas cell is placed in the first vacuum chamber unit that maintains a specific degree of vacuum, and EUV light generated by the plasma induction gas cell is directly delivered to the second vacuum chamber unit having a lower degree of vacuum in order to prevent efficiency from being reduced.

The first vacuum chamber unit and the second vacuum chamber unit include the second vacuum pump 310 and the first vacuum pump 300, respectively, in order to maintain different degrees of vacuum. A plurality of vacuum pumps may be formed in the second vacuum chamber unit in order to form a lower degree of vacuum. For example, medium vacuum-level vacuum pumps, such as a Cryo pump, a diffusion pump, a turbo pump, and an ion pump, may be configured in the second vacuum chamber unit. The first vacuum chamber unit preferably maintains a degree of vacuum of 10⁻³ torr or less, and the second vacuum chamber unit preferably maintains a degree of vacuum of 10⁻⁶ torr or less.

Accordingly, the first vacuum chamber unit is configured to generate EUV light, and the second vacuum chamber unit is configured to prevent efficiency from lowering so that the final light is supplied to an application. In this case, a partition is formed between the divided and configured vacuum chamber units, and an optical lens through which EUV light generated by the plasma induction gas cell may pass is formed in the partition.

Meanwhile, the apparatus for generating EUV light according to the present invention further includes a first aperture 250 additionally applied for the alignment of beams and a second aperture 260 configured to have only light having a center wavelength pass through in order to prevent damage to the optical parts.

The first aperture is used to align laser beams. When a laser is first generated, the first aperture is installed and guides the direction of the laser beam. When such alignment is completed, the first aperture is removed from the EUV light generation apparatus.

When plasma is generated and a EUV beam is generated in a vacuum state, beams having relatively high energy and various wavelength bands may be generated at the same time in addition to the EUV beam and thus several optical parts configured at the back may be damaged if the second aperture 260 is not installed. Accordingly, the second aperture 260 transmits only a beam having a center wavelength so that the beam passes through the center of the second aperture and blocks the remaining beams.

Meanwhile, in order to detect the wavefront of light output by the laser source, a beam splitter 270 installed in the path of light reflected from the TLM and configured to reflect part of the incident light is further included. Accordingly, an image sensor 280 installed outside the vacuum chamber is configured to detect the wavefront of the light reflected from the beam splitter.

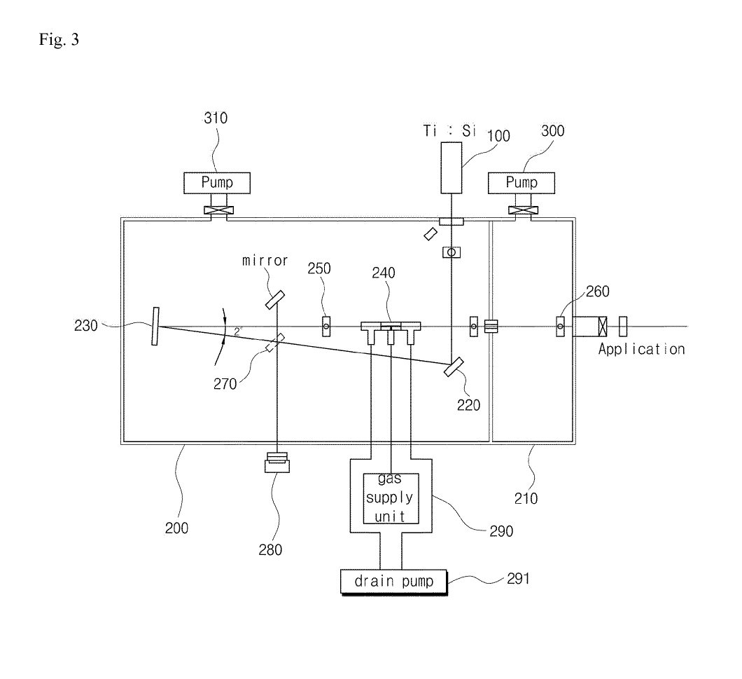

FIG. 3 is a detailed diagram of the apparatus for generating EUV light using plasma according to the present invention. The gas supply line configured to communicate with the outside and to supply gas to the plasma induction line are formed in the plasma induction gas cell by which EUV light is generated through plasma induction. The gas exhaust lines that communicate with the light induction lines are formed on both sides of the gas supply line. Accordingly, the gas supply line is connected to the external gas supply unit 290 and is configured to supply reaction gas required for a plasma reaction. The gas exhaust lines are connected to the external drain pump 291 and are configured to exhaust gas after a reaction to the outside.

Meanwhile, the present invention proposes the plasma induction gas cell, that is, a module for optimizing the induction of output light and a plasma reaction in order to generate EUV light.

The plasma induction gas cell is configured to include a body 1000 configured to have a length form and a specific length, the light induction lines 1100 formed on both sides of the body in the length direction of the body, the plasma induction line 1200 placed between the light induction lines, the gas injection line 1300 configured to communicate with the plasma induction line and to supply external plasma reaction gas, and the gas exhaust lines 1400 configured to communicate with the respective light induction lines and to externally exhaust gas within the plasma induction line.

FIG. 4 is a perspective view of the plasma induction gas cell for generating EUV light according to the present invention. As illustrated, the plasma induction gas cell for generating EUV light is an element having the body of a specific size and includes a chamber, a light source, a plurality of optical systems, and a gas cell that form the EUV light generation apparatus. The gas cell is configured in the EUV light generation apparatus and configured to generate EUV light through a gas reaction.

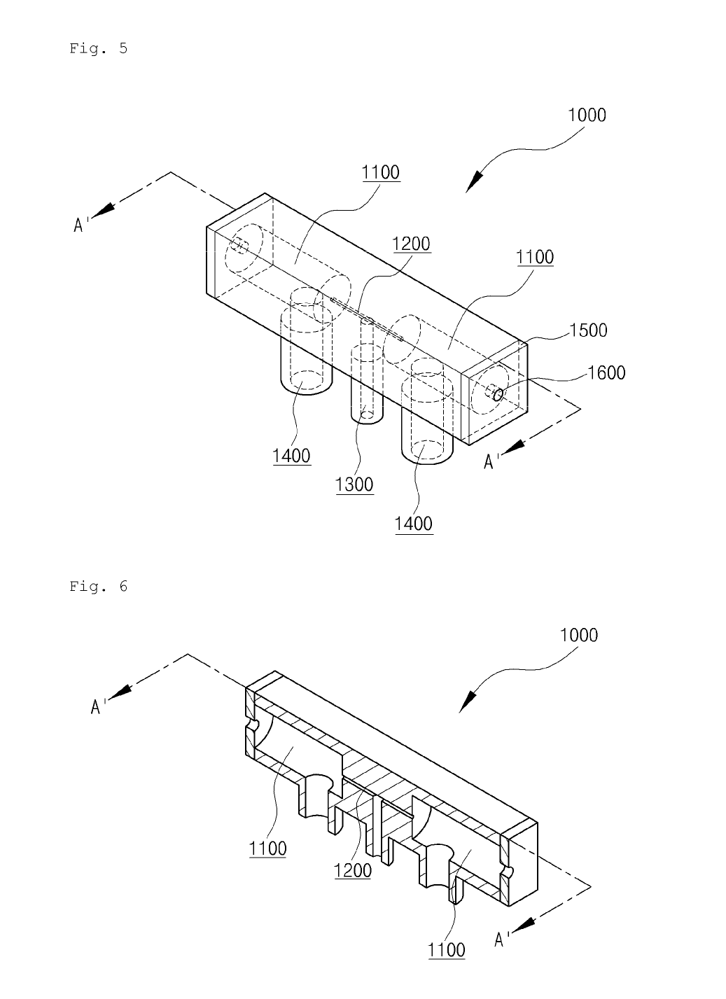

FIG. 5 is a perspective view illustrating the transmission of the plasma induction gas cell according to the present invention.

The gas cell includes the body 1000 having a length form and a specific size. The light induction lines 1100 through which light may penetrate are placed on both sides of the center of the body, respectively, in the length direction of the body. The plasma induction line 1200 for generating EUV light through a plasma reaction is provided between the light induction lines. That is, a hole through which light may penetrate in order of the light induction line, the plasma induction line, and the light induction line so that the light passes through the body is formed in the plasma induction gas cell. EUV light is generated through the plasma induction line.

The body may be preferably made of quartz or fused silica, but is not limited thereto. The body may be made of all types of glass.

FIG. 6 is a cut-away perspective view of the plasma induction gas cell according to the present invention. Referring to FIG. 6, the gas injection line 1300 configured to communicate with the light induction lines so that it is supplied with external gas is formed in the plasma induction line 1200. The gas exhaust lines 1400 configured to externally exhaust gas are formed on both sides of the light induction lines 1100, respectively. That is, a laser beam passing through the plasma induction gas cell reacts to gas supplied by the plasma induction line, thereby generating EUV light of a 20 nm level or less.

A source laser beam externally supplied in order to generate the EUV light is an IR laser of a 800 nm level. An IR laser of 800 nm or more may be used as the source laser. In this case, the IR laser is used, but a laser having a pulse width of femto seconds, that is, an IR femto second laser, needs to be used. A femto second laser having a pulse width of at least 50 fs˜30 fs, from among the IR femto second lasers, is preferably is used.

Furthermore, the reaction gas injected into the gas injection line for a plasma reaction is connected to the external exhaust device through the gas exhaust lines and is externally exhausted. Accordingly, the gas exhaust lines are designed close to the gas plasma induction line to a maximum extent so that gas after a reaction can be rapidly discharged.

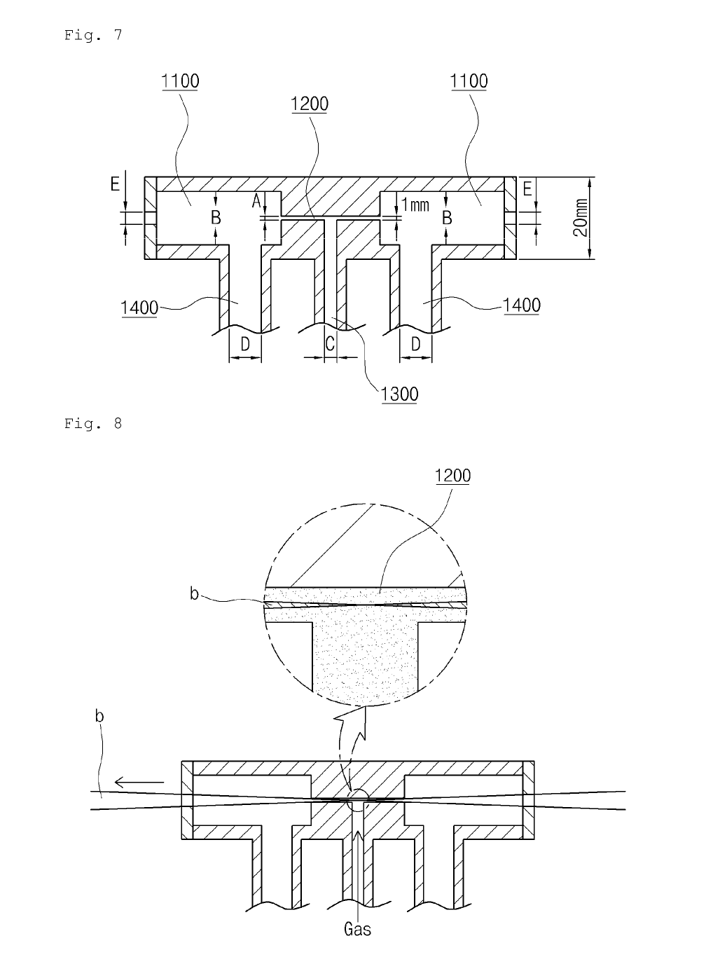

FIG. 7 is a cross-sectional view of the plasma induction gas cell according to the present invention. The structure of the plasma induction gas cell according to the present invention is described in more detail. First, the cross-sectional area of the body is designed to exceed 20×20 mm. The reason for this is that the size of the cross-sectional area is determined in order to prevent the reflection angle of a light path is not disturbed in the EUV light generation apparatus.

Furthermore, the plasma induction line 1200 is formed to have a width A smaller than the width B of the light induction lines. Since injected gas and an injected laser beam react to each other in the plasma induction line 1200, the plasma induction line 1200 has a width of 1 mm or less, preferably, in order to increase the density of the gas for smooth reaction conditions.

Furthermore, the plasma induction line 1200 is preferably configured to have a length smaller than the width C of the gas injection line. The width A of the plasma induction line needs to be smaller than the width C of the gas injection line.

Meanwhile, the plasma induction gas cell further includes side caps 1500 in order to cover the light induction lines opened on both sides of the body. The side caps function to generally cover the light induction lines. The hole 1600 through which incident light may penetrate is provided at the center of the plasma induction gas cell. The hole 1600 is preferably configured to be smaller than the width of the light induction line.

The side caps are separately fabricated and attached and fixed to the sides of the plasma induction gas cell. The side caps function to lower pressure within the light induction lines so that more smooth exhaust is performed.

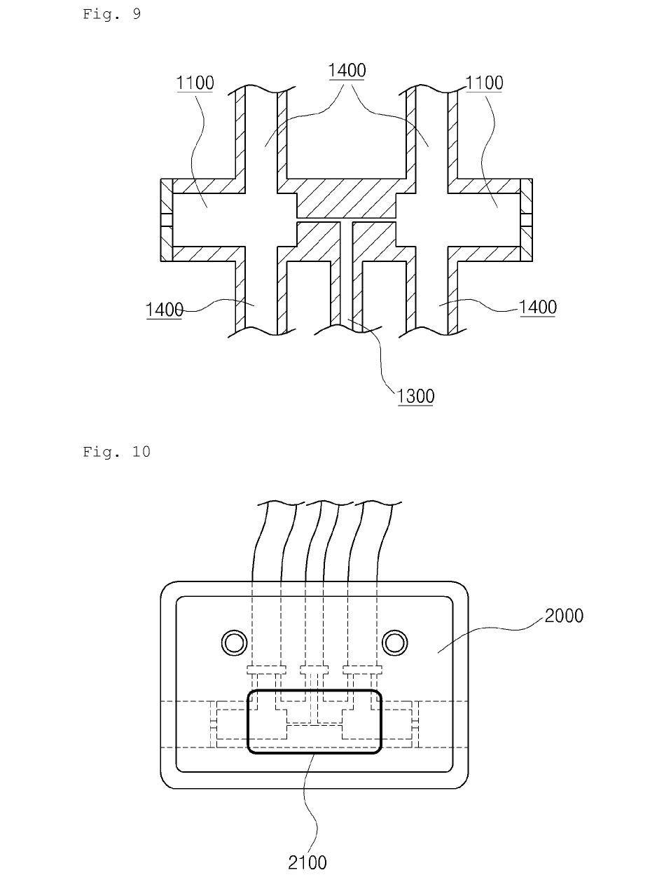

FIG. 8 is a diagram illustrating the light transmission of the plasma induction gas cell according to the present invention. As illustrated, in the plasma induction gas cell, when laser light b is incident from the outside through the light induction line on one side of the plasma induction gas cell, the light incident from the plasma induction line is focused, the focused light reacts to reaction gas supplied to the plasma induction line, and thus EUV light is generated and output through a plasma reaction.

FIG. 9 is a cross-sectional view illustrating a plasma induction gas cell in accordance with another embodiment of the present invention. In order for a reaction gas injected through the gas injection line 1300 to be exhausted through the gas exhaust lines more efficiently, a both-side type exhaust structure may be designed instead of the one-side type exhaust structure configured only on one side for more efficient exhaust. In this case, the gas exhaust lines may be formed close to the plasma induction line to a maximum extent so that gas that is injected through the gas injection line and that remains in the plasma induction line can be rapidly exhausted although they are the one-side type or the both-side type.

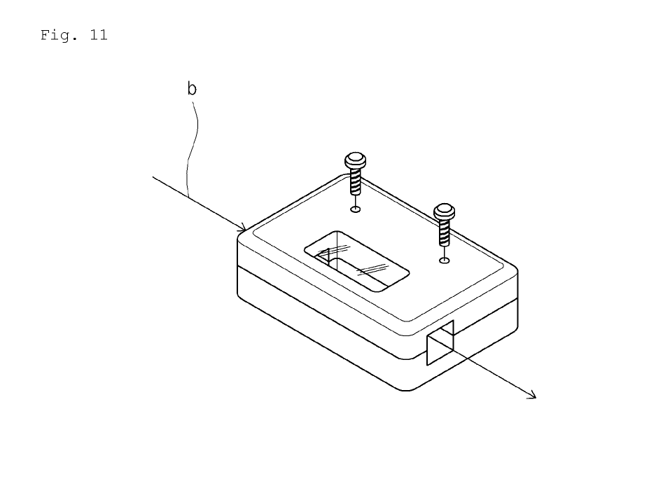

FIG. 10 is a top view illustrating the state in which the plasma induction gas cell has been fixed through a bracket according to the present invention, and FIG. 11 is a perspective view of the fixing bracket of the plasma induction gas cell according to the present invention. The plasma induction gas cell according to the present invention is installed within the vacuum chamber that forms the EUV light generation apparatus. The plasma induction gas cell is installed within the vacuum chamber through a separate fixing bracket 2000. The fixing bracket fixes the plasma induction gas cell within the vacuum chamber. A monitoring window 2100 is provided at a location corresponding to the plasma induction line so that a viewer can monitor the plasma induction line. Furthermore, although not illustrated, a viewer window is also provided at a location corresponding to the fixing bracket in the vacuum chamber so that light focused when laser beams are aligned and a plasma generation type within the plasma induction line can be monitored.

The fixing bracket may be designed in various forms. An open part on which light may be incident needs to be provided within the light induction line. The fixing bracket may have any form if it is open at a location corresponding to the plasma induction line and it provides a viewer window that is externally open. An embodiment may propose a structure in which the fixing bracket 2000 includes upper/lower brackets, a space part capable of fixing the plasma induction gas cell within the fixing bracket 2000 is provided, and the plasma induction gas cell is fixed.

The present invention configured as described above is advantageous in that the structure of an optical system can be very simplified in a process of generating EUV light using a laser beam output by an external laser source, pieces of light can be easily aligned, and the prime cost can be reduced.

Although the present invention has been described in relation to a preferred embodiment of the present invention for illustrating the principle of the present invention, the present invention is not limited to the aforementioned construction and operation. Those skilled in the art will appreciate that the present invention may be changed and modified in various ways without departing from the spirit and scope of the present invention. Accordingly, all the proper changes and modifications and equivalents thereof should be construed as belonging to the scope of the present invention

1. An apparatus for generating extreme ultraviolet (EUV) light using plasma, comprising:
a laser source that outputs lasers;
a Tunable Laser Mirror (TLM) that reflects the laser beams output by the laser source;
a Focusing Mirror (FM) that focuses the laser beams reflected from the TLM;
a gas cell that receives the lasers focused by the FM, receives reaction gas supplied from a gas supply line to a plasma induction line corresponding to a section that is focused, forms plasma using the laser beams and the reaction gas, and generates EUV light; and
a vacuum chamber that accommodates the TLM, the FM, and the gas cell in a vacuum state.

2. The apparatus of claim 1, further comprising:
a first aperture provided to align pieces of the laser beams focused by the FM, and
a second aperture configured to transmit only a center wavelength of the EUV light generated by the gas cell.

3. The apparatus of claim 2, wherein:
the vacuum chamber is divided into a first vacuum chamber unit and a second vacuum chamber unit,
the second vacuum chamber unit is configured to maintain a higher degree of vacuum than the first vacuum chamber unit,
the first vacuum chamber unit is configured to accommodate the TLM, the FM, the gas cell, and the first aperture, and
the second vacuum chamber unit is configured to accommodate the second aperture.

4. The apparatus of claim 1, further comprising:
a beam splitter that reflects part of the light reflected from the TLM; and
an image sensor that detects a wavefront of the beam reflected from the beam splitter.

5. The apparatus of claim 1, wherein the laser source has an IR wave length of 800 nm˜1600 nm and a pulse width of 30 fs˜50 fs.

6. The apparatus of claim 2, wherein the first aperture is removable after the beams output by the FM are aligned.

7. An apparatus for generating extreme ultraviolet (EUV) light using plasma, comprising:
a body having a specific length and a length form;
light induction lines formed on both sides of the body in a length direction of the body;
a plasma induction line placed between the light induction lines;
a gas injection line configured to communicate with the plasma induction line and to supply external plasma reaction gas; and
gas exhaust lines that communicate with the light induction lines and that externally exhaust gas present in the plasma induction line.

8. The apparatus of claim 1, wherein the body further comprises side caps that cover respective open sides of the light induction lines and in which a hole through which light is able to pass is formed.

9. The apparatus of claim 2, wherein the side caps are made of metal materials comprising metal, SUS, aluminum, or copper or made of glass materials comprising quartz or fused silica.

10. The apparatus of claim 1, wherein the body is configured to have a cross-sectional area of 20×20 mm or less.

11. The apparatus of claim 1, wherein the plasma induction line is configured to have a width of 0.9˜1.1 mm.

12. The apparatus of claim 1, wherein the light induction line has a greater width than the plasma induction line.

13. The apparatus of claim 2, wherein the hole is formed be smaller than the light induction line.

14. The apparatus of claim 1, wherein a number of the gas exhaust lines is at least three.

15. The apparatus of claim 1, wherein the body is made of any one of quartz and fused silica.
